(19) United States
(12) Patent Application Publication
(10) Pub. No.: US 2025/0049279 A1
(43) Pub. Date: Feb. 13, 2025

(54) SEPARATOR FOR A FLUID CLEANING DEVICE

(71) Applicant: Dyson Technology Limited, Malmesbury, Wiltshire (GB)

(72) Inventors: Mateusz GUGALA, Gloucester (GB); Geoffrey Robert PYATT, Bristol (GB)

(21) Appl. No.: 18/720,755

(22) PCT Filed: Dec. 14, 2022
(86) PCT No.: PCT/GB2022/053221

§ 371 Date: Jun. 17, 2024

(30) Foreign Application Priority Data
Dec. 17, 2021 (GB) 2118386.8

(51) Int. Cl. A47L 9/10; A47L 9/12; A47L 9/20; B01D 46/00; B01D 46/10

(52) U.S. Cl. CPC A47L 9/104; A47L 9/122; A47L 9/20; B01D 46/0042; B01D 46/10; B01D 2279/55

(57) ABSTRACT

A separator for a cleaning device, the separator comprising: a housing that encloses a separating volume, the housing comprising an inlet for receiving a fluid flow containing entrained debris into the separating volume, and an outlet for discharging a filtered fluid flow output from the separating volume; a filter screen disposed on or in the housing to define part of a boundary of the separating volume, the filter screen being configured to retain the debris in the separating volume while allowing air to exit the separating volume to flow to the outlet; and a spout that is connected to the inlet, wherein the spout comprises a spout outlet through which the fluid flow is discharged into the separating volume, and wherein the spout is configured to direct the fluid flow across the filter screen.

### TECHNICAL FIELD

The invention relates to separators and separating processes for fluid cleaning devices.

### BACKGROUND

Many fluid cleaning devices implement cyclonic separation as an initial stage of purification, to remove the heaviest particles and/or debris from an incoming fluid flow. In the case of vacuum cleaning devices, a separator that implements cyclonic separation may replace a dust bag, in that the separator can be configured to remove and collect larger particulates and debris from an incoming flow of air. This creates a partially filtered flow, which may then be purified further by a fine dust separator and optionally additional filters such as a HEPA (high efficiency particulate air) filter, such that particulates of successively smaller sizes are removed from the flow to produce a purified output. When the separator is full it can be removed, emptied and returned to the device.

Various separator configurations are known, but typically a separator is defined by a hollow housing assembly that encloses an internal volume that is divided into two mutually-isolated chambers by a separating grid, which is also referred to as a ‘shroud’ or ‘mesh’. The mesh acts as a filter screen that allows fluid and particles below a certain size to pass between the chambers, whilst blocking larger particles and debris. Incoming air containing debris is delivered into a first of these chambers, which is therefore an upstream chamber that may be referred to as the ‘primary bin’, whilst the second, downstream chamber on the opposite side of the mesh, or ‘secondary bin’, which may be relatively small and in the form of a duct, the secondary bin being connected to an outlet that conveys a filtered flow on for further purification in additional separation stages. The first and second chambers may be arranged at opposite ends of the housing, or the chambers may be arranged concentrically, for example.

The separator is configured to generate a cyclonic flow in the primary bin that encourages heavier debris to accumulate in a region of the chamber that is spaced from the mesh. Meanwhile, fibres and other lightweight debris that remains in the rotating flow are prevented from passing through to the secondary bin by the mesh.

In existing arrangements, during operation debris accumulates on a surface of the mesh and lodges in pores of the mesh, progressively blocking the mesh and so increasing resistance to air flow through the mesh. Blocking of the mesh in this manner may also be referred to as ‘mesh blinding’. Blinding of the mesh in turn hinders performance of the device until the separator is removed and the mesh is cleaned. The separator may therefore have to be cleaned prematurely before the primary bin is full, which increases the level of user maintenance required. The rate at which the mesh blocks is related to the effectiveness with which debris is deposited at the intended accumulation point in the primary bin relative to the extent to which debris recirculates in the primary bin, in combination with the nature of debris that is being drawn into the separator.

One approach to reducing mesh blinding is to increase the pore size of the mesh to reduce the likelihood of blockage. However, increasing the pore size inevitably allows larger particles to pass through the mesh, to the detriment of the separation efficiency of the separator, namely the proportion of debris that is captured in the primary bin.

Another measure that is taken is to limit the size of an inlet to the primary bin through which incoming air is discharged, in turn ensuring that the velocity of the air flow into the primary bin is high for a given flow rate. This high flow velocity inside the primary bin helps to reduce mesh blinding, but at the cost of increased jetting losses within the primary bin and in turn increased power consumption for the device.

WO 2011/161591 proposes a separator arrangement that is configured to reduce mesh blinding by directing a main inlet air flow at the mesh of a separator, so that the mesh is kept clean by the air flow in use. However, the mesh is vulnerable to damage from large and/or heavy objects that may be entrained in the incoming air flow.

It is against this background that the present invention has been devised.

### SUMMARY OF THE INVENTION

An aspect of the invention provides a separator for a cleaning device. The separator comprises: a housing that encloses a separating volume, the housing comprising an inlet for receiving a fluid flow containing entrained debris into the separating volume, and an outlet for discharging a filtered fluid flow output from the separating volume; a filter screen disposed on or in the housing to define part of a boundary of the separating volume, the filter screen being configured to retain the debris in the separating volume while allowing air to exit the separating volume to flow to the outlet; and a spout that is connected to the inlet. The spout comprises a spout outlet through which the fluid flow is discharged into the separating volume.

The spout is configured to direct the fluid flow across the filter screen. For example, the spout may be configured to direct the fluid flow in a direction that is at an angle of less than 10° with respect to the filter screen, and optionally in a direction that is substantially parallel to the filter screen.

More generally, directing the fluid flow across the screen entails ensuring that an axis corresponding to the direction of the flow does not intersect any part of the screen, such that the fluid does not flow directly at any part of the screen. This in turn ensures that any objects entrained in the flow are not carried into the screen, thereby avoiding a risk of damage to the screen from larger objects.

Directing the fluid flow across the screen also typically entails directing the flow such that the screen defines a boundary of the flow, so that a surface of the screen is exposed to the moving fluid. This enables the fluid flow to clear the screen of particles and debris continuously in use by aerodynamic scrubbing, thereby reducing blinding of the screen. In some embodiments, however, the flow is directed such that it is slightly spaced from the screen, whilst still being generally parallel to the screen, to create a protective curtain across the screen that diverts debris away from the screen.

The spout may be curved along at least part of its length, which may shape the incoming fluid flow to correspond to the shape of the filter screen and may help to reduce blocking of the spout in use. The spout optionally curves in mutually opposed directions.

More generally, the spout may be configured to shape the discharged fluid flow in accordance with the geometry of the filter screen. In this respect, configuring the spout to shape the flow may include tuning or otherwise determining one or more of: the longitudinal profile of the spout; the cross-sectional area of the spout; the cross-sectional shape of the spout; the size of the spout outlet; and the shape of the spout outlet. In one embodiment, for example, the spout outlet is trapezoidal.

The spout may extend into the separating volume from the inlet. Alternatively, the spout outlet may define the inlet of the housing, for example where the spout is at least partially external to the separating volume.

The separator may be configured to establish a secondary flow that circulates around the separating volume. Such a secondary flow may encourage debris to accumulate in a base region of the separating volume away from the filter screen.

Optionally, the inlet and the outlet are disposed at opposed longitudinal ends of the housing, which can provide a compact design.

The filter screen may be oriented at an oblique angle relative to a longitudinal axis of the housing. This may aid guidance of flow within the separating volume and increases the size of the screen that can be used for a housing of a given width or diameter. The filter screen may be oriented at an angle of between 35° and 55°, and optionally at approximately 45° with respect to the longitudinal axis of the housing, for example. The spout outlet may be positioned at or near to an end of the filter screen that is closest to the inlet.

The filter screen may comprise a mesh having a minimum pore size of 250 microns, and optionally 100 microns.

The inlet may define an inlet axis that is parallel to a longitudinal axis of the housing. Similarly, the outlet may define an outlet axis that is parallel to a longitudinal axis of the housing.

The separator may comprise an underslung fine dust collector within the housing. For example, the fine dust collector may extend downwardly from an upper end of the housing. Accommodating the fine dust collector in this way may provide for a compact design and may allow the fine dust collector and the separating volume to be accessible through a common opening of the housing such that they can be emptied in a single operation, for example.

The filter screen may be generally planar. Alternatively, the screen may curve around one or more axes of curvature.

The housing is optionally formed from multiple parts.

The invention also extends to a cleaning device comprising the separator of the above aspect. Such a device may be embodied as a domestic appliance, for example.

Another aspect of the invention provides a method of reducing blockage of a filter screen of a separator for a cleaning device. The filter screen is disposed on or in a housing of the separator to define part of a boundary of a separating volume enclosed by the housing. The housing comprises an inlet for receiving a fluid flow containing entrained debris into the separating volume, an outlet for discharging a filtered fluid flow output from the separating volume, and a spout that is connected to the inlet. The spout comprises a spout outlet through which the fluid flow is discharged into the separating volume. The method comprises configuring the spout to direct the fluid flow across the filter screen, for example by tuning or otherwise determining at least one of: the longitudinal profile of the spout; the cross-sectional area of the spout; the cross-sectional shape of the spout; the size of the spout outlet; and the shape of the spout outlet.

It will be appreciated that preferred and/or optional features of each aspect of the invention may be incorporated alone or in appropriate combination in the other aspects of the invention also.

### BRIEF DESCRIPTION OF THE DRAWINGS

One or more embodiments of the invention will now be described, by way of example only, with reference to the accompanying drawings, in which like features are assigned like numerals, and in which:

FIG. 1 is top view of a separator according to an embodiment of the invention;

FIG. 2 is an axial cross-sectional view of the separator taken through the line A-A in FIG. 1;

FIG. 3 is an axial cross-sectional view of the separator taken through the line B-B in FIG. 1;

FIG. 4 is a radial cross-sectional view of the separator taken through line C-C in FIG. 2;

FIGS. 5a to 5c show perspective views of the separator of FIG. 1 with portions of a housing of the separator hidden;

FIG. 6 corresponds to FIG. 2 but shows air flow inside the separator in use;

FIG. 7 corresponds to FIG. 2 but shows an alternative embodiment of the separator;

FIG. 8 corresponds to FIG. 3 but shows the embodiment of FIG. 7; and

FIGS. 9a to 9c are schematic representations of alternative separator layouts.

### DETAILED DESCRIPTION

In general terms, embodiments of the invention provide separators for fluid cleaning devices that are configured for reduced mesh blinding and low pressure consumption relative to known arrangements. The embodiments described below are configured for use in domestic vacuum cleaning devices, but it will be appreciated that other embodiments of the invention are applicable to a range of cleaning devices.

In embodiments to be described, separators for vacuum cleaning devices are configured to use a primary inlet fluid flow that is discharged into a separating volume defined by an upstream chamber, or ‘primary bin’, of the separator to reduce mesh blinding. More specifically, the primary inlet air flow is directed across the mesh so that the air flows parallel, or close to parallel, to the mesh, such that the air flow continuously clears the mesh when the device is in operation. In this respect, directing the air flow across the mesh entails discharging the air flow into the primary bin in a direction that is parallel, or close to parallel, to the mesh, and often-but not always-sufficiently close to the mesh that a surface of the mesh defines a boundary of the air flow. After passing across the mesh, the air flow is guided around the primary bin to establish a circulating secondary flow within the primary bin that transports debris away from the mesh and typically towards a base region of the primary bin.

Accordingly, the air flow creates a protective curtain across the mesh that acts as a barrier to prevent debris from reaching the mesh, instead directing any debris along and then away from the mesh to accumulate in another part of the primary bin. The relative flow rates across and through the mesh in part determine the effectiveness with which dust is separated and retained in the primary bin, including separation of particles that are of a size that can pass through the mesh.

Although the flow is not directed at the mesh, the flow across the mesh may also remove and/or dislodge any particles that do attach to the mesh by generating high shear stress between the air flow and the particles, which creates an aerodynamic scrubbing effect that captures particles from the surface of the mesh. Accordingly, the air flow provides aerodynamic wiping of the mesh that minimizes the level of manual cleaning of the mesh that may be required and ensures that the mesh does not blind significantly before the primary bin is full.

Continuously washing the mesh using the incoming air flow may allow the pore size of the mesh to be reduced relative to known arrangements that use larger pore sizes to reduce blinding. Reducing the pore size in turn enhances the separation efficiency of the separator.

Conversely, the shapes of the pores become increasingly significant to separation performance in embodiments of the invention, particularly the profiles of the leading edges of the pores with respect to the flow direction of the incoming air flow. In this respect, laser cut pores having straight edges and sharp corners may perform less effectively than electro-formed pores with more curved profiles facing the flow, for example.

Another benefit of embodiments of the invention is that, because the mesh is kept clear by the continuous washing, the inlet through which air enters the primary bin can be made larger, such that the velocity of the inlet flow is lower than in existing designs for a given flow rate. This reduced velocity in turn reduces jetting losses inside the primary bin, which is typically one of the dominant losses in a separator. Accordingly, reducing the jetting losses offers a significant improvement in the overall efficiency of the device. Similarly, the device can achieve the same efficiency as known arrangements whilst consuming less power.

Although the direction of the inlet air flow may not be precisely parallel to the mesh, for example being within 10° of a plane or tangent of the mesh, advantageously the air flow is typically not directed at any part of the mesh and so any larger particles entrained in the air flow that could pose a threat of damage to the mesh are not carried into the mesh.

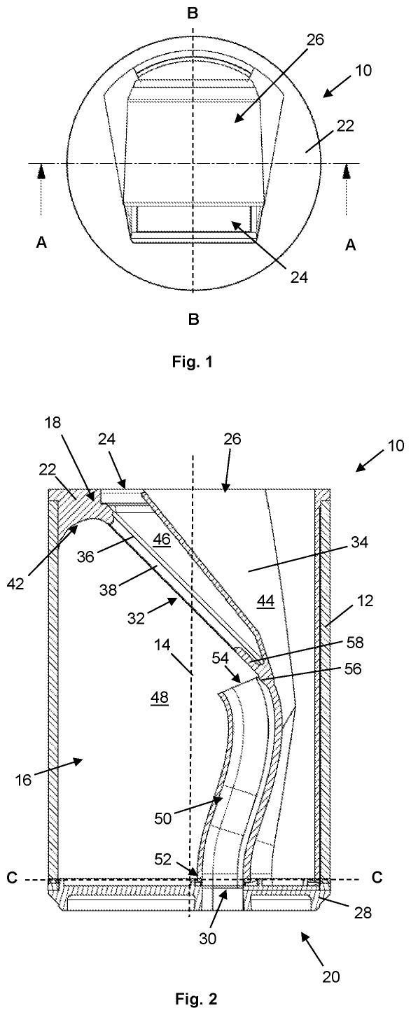

To illustrate the principle more clearly, FIGS. 1 to 6 show a separator 10 according to an embodiment of the invention for use in a device such as a domestic cleaning appliance, and are described collectively in the following description. It is reiterated, however, that the principles of the invention may be used in a range of contexts.

The separator 10 comprises a casing 12 defined by a tubular wall of circular cross section as shown in FIG. 1, which wall encircles a central axis 14 to enclose a cylindrical interior volume 16, the central axis 14 also defining a central longitudinal axis of the separator 10. The casing 12 is configured for use with its central axis 14 oriented vertically as shown in FIG. 2, such that the casing 12 has an upper end and a lower end, the upper and lower ends being at opposed longitudinal ends of the casing 12. It is noted that casings of various shapes may be used in embodiments of the invention, however, including cuboidal casings for example.

The upper end of the casing 12 receives and is closed by an upper separator assembly 18. Correspondingly, the lower end of the casing 12 is closed by a lower separator assembly 20. The casing 12, the upper separator assembly 18 and the lower separator assembly 20 therefore collectively define a housing of the separator 10 that contains the interior volume 16.

The upper separator assembly 18 includes a generally circular upper support plate 22 that is shaped and dimensioned to engage the upper end of the casing 12, for example in a press fit. In this respect, the upper support plate 22 has an upper portion 22a having an outer diameter corresponding to that of the casing 12, and a lower portion of reduced diameter defining a spigot 22b that is received inside the casing 12, the spigot 22b being configured to engage an inner surface of the casing 12 to retain the upper separator assembly 18 on the casing 12.

The upper support plate 22 includes a relatively small trapezoidal opening that defines an outlet 24 of the housing of the separator 10, which defines an outlet axis that is parallel to the central axis 14 of the separator 10. When the separator 10 is in use in the device, the outlet 24 discharges a filtered flow from the separator 10 that is conveyed by suitable connections to additional purification stages within the device. For example, the outlet 24 may deliver the flow to a cyclone pack that acts as a second separator stage.

Directly adjacent to the outlet 24, a second, relatively larger opening defines an entrance 26 to a fine dust collector that is integrated with the upper support plate 22 and accommodated within the separator 10, as described later.

The lower separator assembly 20 includes a generally circular lower support plate 28 that engages the lower end of the casing 12. The lower support plate 28 is coupled to the casing 12 by a hinge (not shown) that enables the lower support plate 28 to pivot between an open position, in which the lower support plate 28 is disengaged from the casing 12, and a closed position, in which the lower support plate 28 engages and closes the lower end of the casing 12. The lower support plate 28 therefore defines a closure for the casing 12.

The lower support plate 28 includes an inlet opening 30 that defines an inlet to the housing of the separator 10 in this embodiment, the inlet opening 30 therefore having an axis that is parallel to the central axis 14 of the separator 10. In use, the inlet opening 30 is connected to ducting within the device through which a flow of air to be filtered is pumped into the separator 10.

Accordingly, the inlet 30 and the outlet 24 of the separator 10 are disposed at opposed longitudinal ends of the casing 12 in this embodiment.

The upper separator assembly 18 further includes a mesh assembly 32 that is mounted to the underside of the upper support plate 22 directly beneath the outlet 24. The mesh assembly 32 includes a mesh support defined by a pair of parallel, planar, triangular mesh support walls 34 that extend axially downwardly from an underside of the upper support plate 22 into the casing 12. Each mesh support wall 34 has a support edge 36 corresponding to a hypotenuse of the triangle, the support edge 36 being inclined relative to the central axis 14 and extending from a rear portion of the housing on one side of the central axis 14 to a front portion of the housing on an opposite side of the central axis 14.

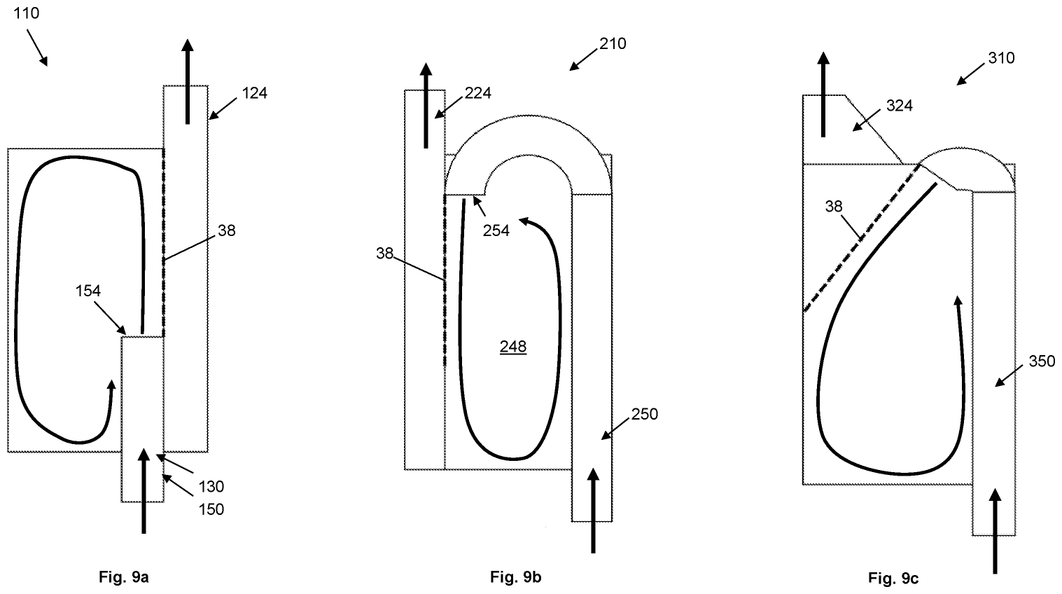

A planar, generally oblong mesh 38 is supported between the support edges 36 of the support walls 34, such that the central axis 14 intersects the mesh 38 at approximately its centre and at an oblique angle of approximately 45°. This inclination defines a base of the mesh 38, namely an end of the mesh 38 closest to the lower end of the housing. Correspondingly, a top of the mesh 38 is defined at the end of the mesh 38 closest to the upper end of the housing. It is noted, however, that in other embodiments the mesh 38 may be at any orientation with respect to the central axis 14. Some examples of different layouts are shown in FIGS. 9a to 9c, which are described later.

The mesh 38 is a porous screen configured to act as a filter screen, and may have a pore size in the range of 100-500 microns, for example. The pores may have various shapes, including circular, oval or polygonal pores, for example. Rectangular pores, where used, may be oriented perpendicular to the incoming flow direction. As noted above, the profiles of the leading edges of the pores, relative to the direction of the incoming air flow, may be particularly influential with respect to the separating performance of the mesh 38, with curved profiles typically offering superior separating performance. Similarly, the upstream surface of the mesh 38 that is exposed to the incoming air flow may be curved for enhanced performance.

The mesh 38 may be formed of plastic, or from metal with the pores being chemically-etched or electro-formed. The mesh 38 may mount to the support edges 36 of the mesh support walls 34 in any suitable way. For example, the mesh 38 may slide into slots formed on inner faces of the walls.

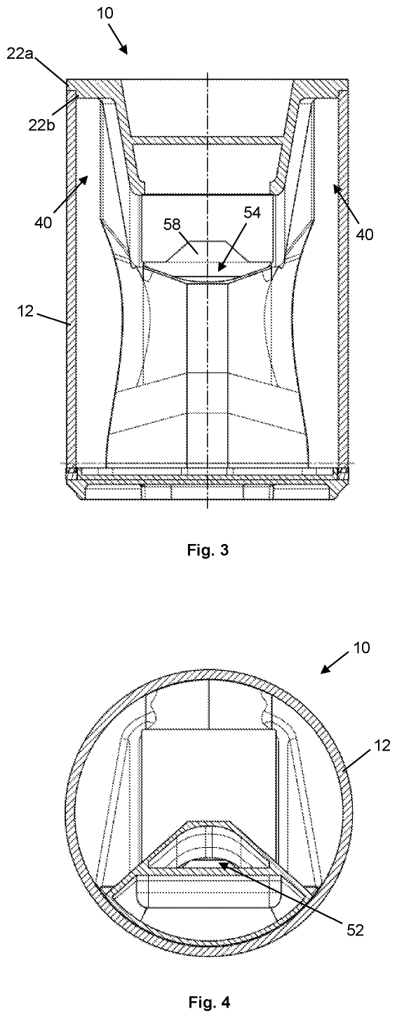

As FIG. 3 shows, the mesh 38 extends over approximately half of the diameter of the separator casing 12, such that cavities 40 are defined on each side of the mesh 38. This reduces the space that is occupied by the mesh assembly 32 and in turn increases the capacity of the separator 10 for debris. The cavities 40 also protect the mesh 38 when the separator 10 is inverted, for example when a user operates the device to clean a ceiling, by providing a space in which debris can collect around the mesh 38.

In this embodiment, the mesh 38 has a surface area of 42 cm², which the skilled person will appreciate is relatively low compared to known arrangements. This small size, in combination with the orientation of the mesh 38 and the corresponding compactness of the mesh assembly 32, minimizes the proportion of the capacity of the separator volume 16 that is occupied by the mesh assembly 32.

The top of the mesh 38 adjoins an arcuate flow guide 42 that extends from the upper support plate 22, the flow guide 42 being shaped to define a flow path that leads from the top of the mesh 38, curves around the upper corner of the housing and then directs air flow downwardly along the interior of the wall of the casing 12, in use.

To the right of the mesh assembly 32, as viewed in FIG. 2, the support walls 34 of the mesh assembly 32 connect to an elongate container defining a fine dust collector 44, which is integral with, and extends downwardly from, the underside of the upper support plate 22 at the rear of the housing to engage the lower support plate 28 at the bottom of the housing. The fine dust collector 44 is therefore underslung with respect to the upper support plate 22. The fine dust collector 44 is shaped to lie against the interior of the wall of the casing 12, and encloses a volume in which fine dust that is discharged from a secondary separation stage such as a cyclone pack can collect.

The container is open at its lower end and is arranged to be closed by the lower support plate 28 when the lower support plate 28 is in its closed position. Correspondingly, pivoting or otherwise moving the lower support plate 28 to its open position allows the fine dust collector 44 to be emptied.

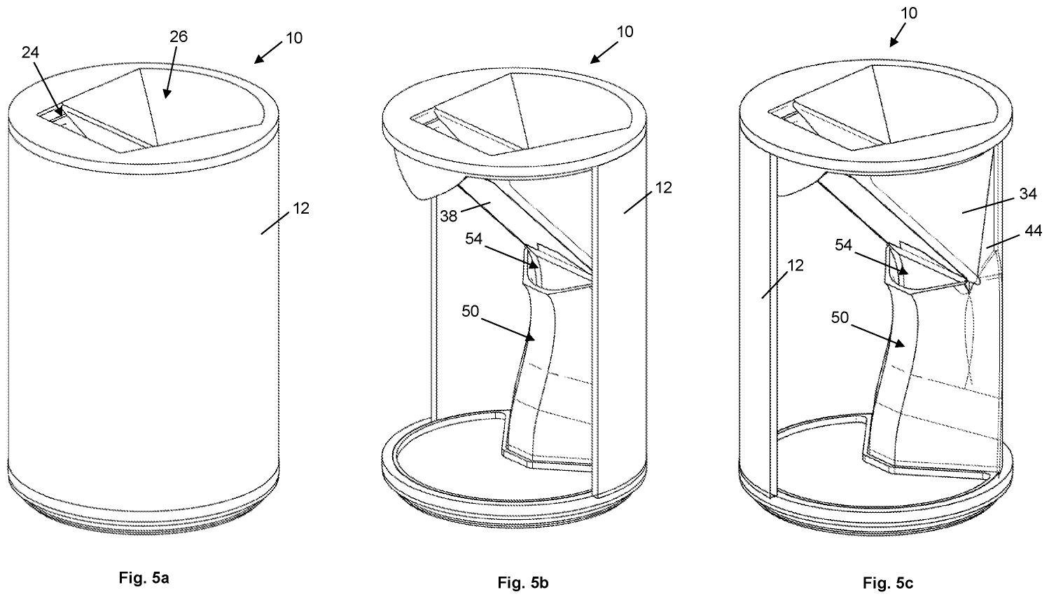

Above the mesh 38, as viewed in FIG. 2, a wall extends from a part of the mesh assembly 32 close to the base of the mesh 38 to the central opening 24 of the upper support plate 22, the wall being slightly offset from, and diverging gently upwardly from, the mesh 38. This wall seals a volume behind the mesh 38 that is isolated from the fine dust collector 44, while being in communication with the outlet 24, to direct air passing through the mesh 38 to the outlet 24. This sealed space defines a secondary bin 46 of the separator 10, which in this embodiment is in the general form of a duct that terminates at the outlet 24 of the separator 10 defined in the upper support plate 22. An upper end of the wall of the secondary bin 46 therefore also separates the outlet 24 from the entrance 26 to the fine dust collector 44, as seen most clearly in FIGS. 5a to 5c. Meanwhile, the remaining parts of the volume 16 of the casing 12 outside the fine dust collector 44 and the mesh assembly 32 define the primary bin 48 of the separator 10, the primary bin 48 occupying the majority of the volume 16 of the casing 12.

The mesh 38 forms part of a boundary of a separating volume defined by the primary bin 48, such that air in the primary bin 48 must pass through the mesh 38 to reach the secondary bin 46 and the outlet 24, such that the secondary bin 46 defines a downstream chamber of the separator 10. The mesh 38 prevents particles of a certain size from passing into the secondary bin 46, so that such particles accumulate in the primary bin 48.

It is noted that moving the lower support plate 28 to its open position creates access to both the primary bin 48 and the fine dust collector 44. Accordingly, conveniently the primary bin 48 and fine dust collector 44 can be emptied together in a single operation.

The remaining space inside the casing 12 is occupied by the fine dust collector 44, which is sealed from both the primary bin 48 and the secondary bin 46. When the lower support plate 28 is closed the fine dust collector 44 is accessible only through its entrance 26 defined in the upper support plate 22, which communicates with a dust outlet of a secondary separation stage of the device upstream of the separator 10, for example a cyclone pack.

As FIG. 2 shows best, a duct is formed on top of the fine dust collector 44 by an additional wall that merges with the exterior of the fine dust collector 44, this merging being most clearly visible in FIG. 5c. The duct defines an inlet spout 50 that follows a generally upward, albeit meandering path from a spout base 52 at the bottom of the housing to terminate at a spout outlet 54 disposed at the base of the mesh 38.

As best seen in FIG. 2, a small lip 56 is formed at the radially outer edge of the spout outlet 54 where the spout 50 meets the mesh 38, the lip 56 protruding into the spout 50 and serving to guide airflow slightly away from the base of the mesh 38, to protect the mesh 38 from larger particles. For similar reasons, a trapezoidal impact plate 58 is provided at the base of the mesh 38 to cover the region of the mesh 38 that is most vulnerable to impacts from larger particles entrained in the incoming air flow.

As FIG. 4 reveals, the spout base 52 forms a trapezoidal opening that, as FIG. 2 shows, aligns with the inlet opening 30 of the lower support plate 28 when the plate 28 is closed, with a suitable seal being provided at the interface between the spout base 52 and the inlet opening 30. Accordingly, the spout 50 and the inlet opening 30 combine to form a continuous flow path for incoming air. In use, an inlet air flow entering the separator via the inlet opening 30 is conveyed along this path and discharged through the spout outlet 54 across the mesh 38 and into the primary bin 48.

The inlet air flow is drawn into the separator 10 through the spout 50 by suction induced by a vacuum motor of the device. The motor is disposed downstream of the outlet 24 of the separator 10, and therefore applies suction to the outlet 24 to create the air flow through the separator 10.

As FIG. 2 shows, the path of the spout 50 curves gently in opposed directions between the bottom of the housing and the spout outlet 54, such that the spout 50 has a swan neck profile and the spout outlet 54 is offset horizontally from, and inclined relative to, the spout base 52. In this respect, in an end portion of the spout 50 that includes the spout outlet 54 the spout 50 has an axis that is substantially parallel to the mesh 38, such that air discharged from the spout outlet 54 is directed along this path to flow across the mesh 38.

The radial depth and the circumferential width of the spout 50 are each substantially uniform along its length, so that the spout 50 has a generally constant cross section along its length. Accordingly, as FIGS. 5b and 5c show the spout outlet 54 has a trapezoidal cross section similar to that of the spout base 52.

The cross-sectional area of the spout outlet 54 is relatively large compared to similar existing arrangements, for example more than 50% larger. This reduces the speed at which air flows into the primary bin 48, leading to a pressure consumption in the primary bin 48 that may be less than half of that of existing arrangements. This in turn offers a significant improvement in the overall efficiency of the device in which the separator 10 is used.

This shaping of the spout 50 is tuned and optimized to guide the fluid conveyed through the spout 50 such that it exits through the spout outlet 54 in a direction that is substantially parallel to the surface of the mesh 38. The shaping of the spout 50 and the spout outlet 54 also causes the flow to spread out evenly across the surface of the mesh 38, such that the shape of the flow substantially matches the shape of the mesh 38 and all areas of the mesh 38 are subjected to the cleaning flow. The flat, rectangular shape of the mesh 38 further contributes to an even flow across the mesh 38.

The curves of the spout 50 each have a radius of curvature that is substantially greater than the radial depth of the spout 50, for example at least twice the depth of the spout 50, such that the 45° through which the spout 50 turns between the spout base 52 and the spout outlet 54 is spread over the length of the spout 50. Avoiding sharp turns in the inlet path helps to ensure that debris does not accumulate in the spout 50, which could otherwise cause blockages. Providing an inlet flow path that is relatively straight also minimizes pressure losses in the spout 50, in turn reducing the pumping power required to convey fluid through the spout 50 and hence improving the efficiency of the cleaning device, but without risking increased mesh blinding as would be a concern in arrangements lacking the aerodynamic wiping of the present example.

It is noted, however, that the shape of the spout 50 may be varied in practice, and various shapes are possible that provide the required effect of shaping the incoming air flow with minimal pressure losses. So, for example, the spout 50 may have a single curve that extends partway or fully along the length of the spout 50, multiple curves in similar directions or multiple curves in differing directions. The spout 50 may also not have uniform depth and width along its length as in the present example.

Similarly, the spout outlet 54 may not be trapezoidal as in the present embodiment, but may alternatively be circular, oval, rectangular or a blend of those shapes, for example. The shape that is selected is tuned to optimize spreading of the airflow across the mesh 38.

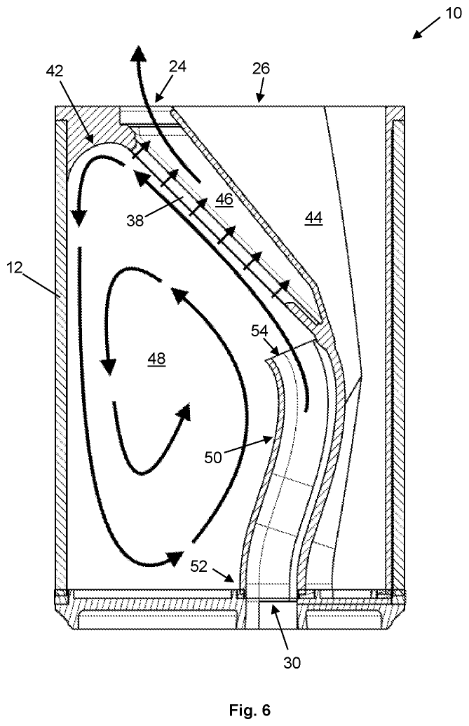

Referring now also to FIG. 6, air flowing across the mesh 38 eventually reaches the curved flow guide 42 at the top of the mesh 38, which then guides the flow around the top corner of the housing and then to flow downwardly along the periphery of the primary bin 48, as indicated by the arrows in FIG. 6. In this part of the flow, the air flows as a focused jet with relatively high velocity. Once the air reaches the bottom of the primary bin 48 it will turn again to follow the curved exterior of the spout 50 and fine dust collector 44 to flow back up towards the mesh 38. While turning at the bottom of the primary bin 48, the flow transitions from a focused jet to a slower, distributed flow.

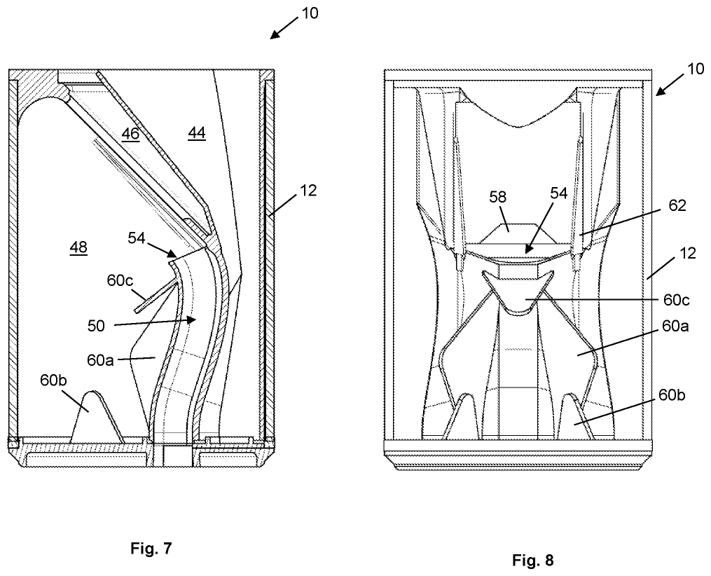

The overall effect is to create a circulatory secondary flow inside the primary bin 48 that acts to separate larger and/or heavier debris, whose momentum and weight precludes such particles being carried upwardly back towards the mesh 38, therefore causing such debris to be deposited and accumulate at the bottom of the primary bin 48. Smaller and/or lighter debris such as fluff and fibres also accumulate at the bottom of the primary bin 48, and in turn accumulated fluff and fibre can help to catch dust circulating in the secondary flow. The change in speed of the flow as it turns at the bottom of the primary bin 48 further promotes deposition of debris. Baffles and other flow guides may be included to promote deposition of particles at the bottom of the primary bin 48, as described later with reference to FIGS. 7 and 8.

Meanwhile, lighter particles that may continue to circulate with the secondary flow to return to the mesh 38 are prevented from attaching to the mesh 38 by the continuous flow across the mesh 38 from the spout 50. So, only air and particles that are smaller than the pores of the mesh 38 can pass through the mesh 38 to flow into the secondary bin 46 and on towards the outlet 24. As noted above, when the separator 10 is used in a cleaning device some of the finer particles that do pass through the mesh 38 are subsequently removed from the flow by a secondary separation stage such as a cyclone pack and trapped in the fine dust collector 44, for example via cone tips. The device may incorporate a further filter such as a HEPA filter downstream of the outlet 24 to provide a further level of purification.

To control movement of air and debris within the primary bin 48 and to promote accumulation at the base of the primary bin 48, baffles may be provided around the interior of the primary bin 48 to act as auxiliary flow guides and to resist movement of debris towards the mesh 38. FIGS. 7 and 8 show such an arrangement, in which two pairs of baffles 60 are visible: a first pair 60a extending along each side of the spout 50, and a second pair extending upwardly from positions on the lower support plate 28 to each side of the spout 50. A further baffle 60c extends from the front of the spout from a position close to the spout outlet 54. The baffles constrain air flow within the separator 10 to circulate substantially as shown in FIG. 6.

FIG. 8 also shows optional guard walls 62 that project from each support edge 36 of the mesh assembly 32, the guard walls 62 serving both to protect the mesh 38 and to constrain and guide the flow across the mesh 38.

The embodiment shown in FIGS. 7 and 8 is otherwise identical to that of FIGS. 1 to 5.

FIGS. 9a to 9c show, in simplified schematic form, various alternative topologies for the separator.

In FIG. 9a, a separator 110 is shown in which a mesh 38 extends vertically, an inlet spout 150 is straight and extends vertically through an inlet opening 130 into the primary bin 148 from a lower end of the bin to terminate at a spout outlet 154 that is positioned at the base of the mesh 38. Meanwhile, an outlet 124 extends from the top of the separator 110. The inlet and the outlet 124 therefore define respective axes that are parallel to but offset from one another.

FIG. 9b shows another configuration for a separator 210 in which the mesh 38 and the outlet 224 are configured in the same way as for the configuration shown in FIG. 9a, but in which the spout 250 extends from the lower end of the primary bin 248, curves around the top of the primary bin 248 and the terminates at a spout outlet 254 at the top of the mesh 38, to discharge air downwardly across the mesh 38 in use. Notably, this spout 250 may be external to the primary bin 248 apart from the final, downwardly extending portion.

FIG. 9c shows a configuration for a separator 310 in which the inlet spout 350 and the outlet 324 are configured in a similar manner to the configuration of FIG. 9b, but in which the mesh 38 is inclined relative to the vertical. Again, the spout 350 could be predominantly external to the bin in this configuration.

FIGS. 9a to 9c therefore demonstrate the flexibility with which the spout and the mesh 38 may be configured. In each case, the spout can nonetheless be configured to shape the flow of air across the mesh 38 according to the principles set out above.

It will be appreciated that various changes and modifications can be made to the present invention without departing from the scope of the present application.

For example, although the above described embodiments use flat meshes, in other embodiments meshes that curve around one or more axes may be used.

It may be possible to form the separator housing using a different number of separate elements. For example, the upper separator assembly could be formed integrally with the casing.

1. A separator for a cleaning device, the separator comprising:
a housing that encloses a separating volume, the housing comprising an inlet for receiving a fluid flow containing entrained debris into the separating volume, and an outlet for discharging a filtered fluid flow output from the separating volume;
a filter screen disposed on or in the housing to define part of a boundary of the separating volume, the filter screen being configured to retain the debris in the separating volume while allowing air to exit the separating volume to flow to the outlet; and
a spout that is connected to the inlet, wherein the spout comprises a spout outlet through which the fluid flow is discharged into the separating volume, and wherein the spout is configured to direct the fluid flow across the filter screen.

2. The separator of claim 1, wherein the spout is configured to direct the fluid flow in a direction that is at an angle of less than 10° with respect to the filter screen.

3. The separator of claim 2, wherein the spout is configured to direct the fluid flow in a direction substantially parallel to the filter screen.

4. The separator of claim 1, wherein the spout is curved along at least part of its length.

5. The separator of claim 4, wherein the spout curves in mutually opposed directions.

6. The separator of claim 1, wherein the spout is configured to shape the discharged fluid flow in accordance with the geometry of the filter screen.

7. The separator of claim 1, wherein the spout outlet is trapezoidal.

8. The separator of claim 1, wherein the spout extends into the separating volume from the inlet.

9. The separator of claim 1, wherein the spout outlet defines the inlet of the housing.

10. The separator of claim 1, configured to establish a secondary flow that circulates around the separating volume.

11. The separator of claim 1, wherein the inlet and the outlet are disposed at opposed longitudinal ends of the housing.

12. The separator of claim 1, wherein the filter screen is oriented at an oblique angle relative to a longitudinal axis of the housing.

13. The separator of claim 12, wherein the filter screen is oriented at an angle of between 35° and 55° with respect to the longitudinal axis of the housing.

14. The separator of claim 12, wherein the spout outlet is positioned at or near to an end of the filter screen that is closest to the inlet.

15. The separator of claim 1, wherein the filter screen comprises a mesh having a minimum pore size of 250 microns, and optionally 100 microns.

16. The separator of claim 1, wherein the inlet defines an inlet axis that is parallel to a longitudinal axis of the housing.

17. The separator of claim 1, wherein the outlet defines an outlet axis that is parallel to a longitudinal axis of the housing.

18. The separator of claim 1, comprising an underslung fine dust collector within the housing.

19. The separator of claim 1, wherein the filter screen is generally planar.

20. (canceled)

21. (canceled)

22. (canceled)

23. A method of reducing blockage of a filter screen of a separator for a cleaning device, the filter screen being disposed on or in a housing of the separator to define part of a boundary of a separating volume enclosed by the housing, the housing comprising an inlet for receiving a fluid flow containing entrained debris into the separating volume, an outlet for discharging a filtered fluid flow output from the separating volume, and a spout that is connected to the inlet, the spout comprising a spout outlet through which the fluid flow is discharged into the separating volume, wherein the method comprises configuring the spout to direct the fluid flow across the filter screen.

24. (canceled)
